(19) United States
(12) Patent Application Publication
(10) Pub. No.: US 2011/0181996 A1
(43) Pub. Date: Jul. 28, 2011

(54) BATTERY OPERATED, AIR INDUCTION IONIZING BLOW-OFF GUN

(76) Inventor: Thomas E. CAFFARELLA, Grand Island, NY (US)

(21) Appl. No.: 12/692,190

(22) Filed: Jan. 22, 2010

(51) Int. Cl. H01T 23/00

(52) U.S. Cl. 361/231

(57) ABSTRACT

An ionizing blow-off gun including a barrel having an open rearward end for drawing in ambient air and an open forward end for discharging an ionized airstream, an air induction device downstream from the open rearward end, a compressed gas pathway connected to the air induction device, a self-contained ionization system, and a lock coupled to a battery. The self-contained ionization system includes a removable emitter pin positioned downstream from the air induction device, a high voltage, alternating current power supply coupled to the emitter pin to provide the operating voltage for the emitter pin, a battery connected to the power supply, and a switch that allows electric current from the battery to flow into the power supply. In the locked position, the lock disconnects the battery from the power supply so the emitter pin can be removed without electric current flowing.

### TECHNICAL FIELD

The present invention is directed to a static eliminator and more particularly to a generally gun-shaped, battery powered, air induction, ionizing blower for removing statically charged particles from a surface.

### BACKGROUND

Static is the accumulation of electrical charges on the surface of a non-conductive material. Static can be produced when two different non-conducting materials are rubbed together. The electric fields associated with electrostatic charges on a surface attract dirt, dust, and other contaminants. If the dirt, dust, and other contaminants are present on a surface, such as a surface to be painted, the end product may have poor quality, which can result in increased process costs due to rework.

Attempts to merely blow dust off of a statically charged surface is a temporary solution at best. Because the static charge remains, additional dust particles will be attracted and held to the surface. Moreover, attempts to wipe or brush dust from a statically charged surface may aggravate the problem by increasing the static charge on the surface.

Numerous methods and devices have been developed to reduce or eliminate static charge. One such method uses ionized air to neutralize static charge on a surface or the dust particles attracted to the surface. Devices for producing ionized air are well known and include high voltage electronic devices that use a corona discharge and radioactive devices that emit alpha particles. It is also known to use these devices in combination with electric fans or compressed air sources to direct the ionized air at the surface to be cleaned. Several examples of known ionizers are disclosed in U.S. Pat. Nos. 1,731,030, 3,156,847, 3,179,849, 4,258,408, 4,333,123, 4,438,479, 4,665,462, 5,095,400, 5,388,769, 5,508,880, 6,118,645, 6,373,680, 6,739,530 and 6,850,403 and U.S. Pat. Publication No. 2004/0118428.

Known ionizers that use external power supplies, often those using a high voltage power supply, are attached to the power supply by a cumbersome cord, which results in a lack of mobility and often coordination of the power cord and a compressed gas hose. Ionizers that utilize an electric fan or pump are often heavy or bulky and require access to a power source or batteries. Likewise, ionizers that use canned compressed air, although mobile, are expensive due to the cost of replacement air cans.

Some ionizers include a corona discharge that has an emitter pin that is exposed to dust, dirt, or other contaminants that may collect on the pin. The contaminants degrade the efficiency of the apparatus. Furthermore, emitter pins erode over time simply due to use. The ionizers, like those above, are discarded when the emitter pin erodes or is contaminated. This is expensive.

Therefore, a new ionizing blow-off gun is desired that is lightweight, mobile, has a self-contained power supply including a battery and a replaceable emitter pin.

### SUMMARY

According to a first aspect an ionizing blow-off gun is provided comprising a barrel including an open rearward end for drawing in ambient air and an open forward end for discharging an ionized airstream, an air induction device within the barrel downstream from the open rearward end, a compressed gas pathway connected to the air induction device to direct a compressed gas into the air induction device to form a high volume, high velocity airstream of ambient and compressed air directed toward the forward end, a self-contained ionization system, and a lock coupled to an on-board battery. The self-contained ionization system includes a removable emitter pin within the barrel downstream from the air induction device, a high voltage, alternating current power supply coupled to the emitter pin to provide the operating voltage for the emitter pin, a battery connected to the power supply, and a switch that allows electric current from the battery to flow into the high voltage, alternating current power supply. In the locked position, the lock disconnects the battery from the power supply so the emitter pin can be removed without electric current flowing to the high voltage, alternating current power supply.

According to a second aspect, the ionizing blow-off gun further comprises a nozzle coupled to the open forward end of the barrel. The nozzle is removable to provide access to the emitter pin so that the emitter pin can be removed and replaced.

According to a third aspect, an ionizing blow-off gun is provided comprising a barrel including an open rearward end for drawing in ambient air and an open forward end for discharging an ionized airstream, an air induction device within the barrel downstream from the open rearward end, a compressed gas pathway connected to the air induction device to direct a compressed gas into the air induction device to form a high volume, high velocity airstream of ambient and compressed air directed toward the forward end, a self-contained ionization system, and a trigger that upon activation opens the compressed air pathway and closes the switch. The self-contained ionization system includes an emitter pin within the barrel downstream from the air induction device, a high voltage, alternating current power supply coupled to the emitter pin to provide the operating voltage for the emitter pin, a battery connected to the power supply, and a switch that allows electric current from the battery to flow into the high voltage, alternating current power supply.

### BRIEF DESCRIPTION OF THE DRAWINGS

FIG. 1 is a side perspective view of one embodiment of an ionizing blow-off gun.

FIG. 2 is a cross-sectional view of the ionizing blow-off gun of FIG. 1.

FIG. 3 is a side view of one embodiment of an ionizing blow-off gun without its outer housing.

FIG. 4 is a front perspective view of one embodiment of an ionizing blow-off gun with the nozzle removed.

FIG. 5 is a partial side perspective view of one embodiment of an ionizing blow-off gun showing the assembly of a removable filter.

FIG. 6 is a block circuit diagram of a corona discharge ionizer suitable for use in the ionizing blow-off gun of FIG. 1.

FIG. 7 is a graph comparing the Charge Plate Discharge Time of a battery-powered prior art gun and the battery powered ionizing blow-off gun of FIG. 1.

FIG. 8 is a graph of Air Volume Output of a battery-powered prior art gun and the battery powered ionizing blow-off gun of FIG. 1.

### DETAILED DESCRIPTION

Disclosed herein is an embodiment of an ionizing blow-off gun, generally designated 100. When the ionizing blow-off gun is pictured in the figures without its outer housing 110, the gun is generally designated 101. The ionizing blow-off gun uses compressed gas to draw in ambient air to form a compressed gas-ambient air airstream that has high volume and high velocity. The compressed gas-ambient air airstream is ionized in the barrel of the gun by a corona discharge emitter and is then directed toward a surface to be cleaned of dust, dirt, and other contaminants that may be bound to the surface by electrostatic charges. The corona discharge emitter ionizes the compressed gas-ambient air airstream so that the airstream contains both positive and negative ions. The positive and negative ions in the airstream effectively remove oppositely charged electrostatic charges at the target surface to remove dust, dirt and other contaminants and to reduce the collection of additional contaminants back onto the surface.

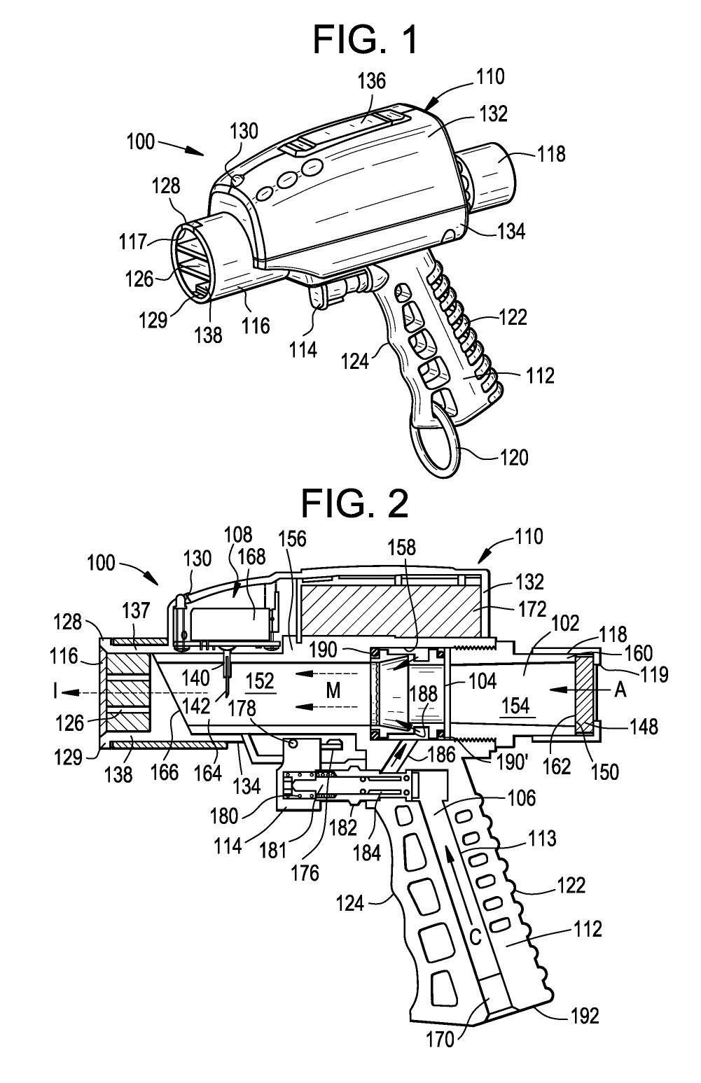

Referring now to FIGS. 1-2, the ionizing blow-off gun 100 includes a barrel 102 having an air induction device 104 and includes a compressed gas pathway 106 connected to the air induction device 104, a self-contained ionization system 108, and a trigger 114. The ionizing blow-off gun 100 may also comprise an outer housing 110, a handle 112, a nozzle 116, and a rear cap 118. The handle 112 may include a palm grip 122 and a finger grip 124 and an attachment member 120 such as a ring, hook, clip, or the like for attaching the ionizing blow-off gun 100 to another object.

The barrel 102 has a rearward end 160 that defines a first opening 162 and a forward end 164 that defines a second opening 166. The rearward end 160 is open to draw in ambient air A. The forward end 164 is open to discharge an ionized airstream I. To draw in the ambient air A, the barrel 102 includes an air induction device 104. The air induction device 104 is positioned within the barrel 102 downstream of the open rearward end 160.

In one embodiment, best seen in FIG. 2, the forward end 164 and the rearward end 160 are part of separate segments of the barrel 102 with the air induction device 104 sandwiched in between. The forward end 164 is part of a forward segment 152 and the rearward end 160 is part of a rearward segment 154. A seal 190 may be included between the air induction device 104 and the forward segment 152 and a second seal 190′ may be included between the air induction device 104 and the rearward segment 154. The forward segment 152 may be integrally formed with the handle 112 as part of the gun body 156. The gun body 156 may include a cavity 158 adjacent and to the rear of the forward segment 152 that has a larger bore than the barrel 102 so that the cavity can receive and house the air induction device 104. The cavity 158 may also include a means for connecting to at least a portion of the rearward segment 154. The means for connecting the rearward segment 154 to the cavity 158 may be threading, a press-fit connection, a snap-fit connection, a latch, or other connectors known to one of skill in the art.

The air induction device 104 is aligned with the barrel 102 so that air drawn in through the rearward end 160 can flow through the air induction device 104. The air induction device 104 includes one or more side ports 188 in fluid communication with the compressed gas pathway 106. The side ports 188 are small in volume in comparison to the central volume of the device. Compressed gas C entering the air induction device 104 via the side ports 188 is directed toward the open forward end 164 and creates a low pressure area within the central portion of the air induction device 104, which induces a high volume flow of the surrounding ambient air into the airstream within the barrel 102. This results in a high volume, high velocity airstream of combined compressed gas-ambient air M flowing toward the open forward end 164. The air induction device 104 may be an air amplifier available from EXAIR Corporation, a Round Transvector available from Vortec, or the like.

The compressed gas pathway 106 may be located in the gun body 156, in particular in the handle 112. In the embodiment of FIG. 2, the compressed gas pathway 106 includes a bore 113 running the majority of the length of the handle, a valve 184, and a connection bore 186 that connects the valve 184 to the air induction device 104, in particular to its side port(s) 188. The bore 113 may terminate at the butt 192 of the handle 112 with a connector 170 for connecting to a source of compressed gas. The connector 170 may be connectable to a hose coupled to the source of compressed gas. The compressed gas may be set at an inlet pressure of about 30 psi to about 50 psi, preferably about 30 psi. Preferably, the source of compressed gas is clean, dry compressed air.

Now referring to FIG. 2, the ionizing blow-off gun 100 includes a self-contained ionization system 108. The self-contained ionization system 108 is enclosed within an outer housing 110 that also encloses the air induction device 104 and at least part of the barrel 102. The ionization system 108 includes an emitter pin 142 within the barrel 102 downstream from the air induction device 104, a high voltage, alternating current power supply 168 coupled to the emitter pin 142 to provide its operating voltage, a battery 172 connected to the power supply 168, and a switch 176 that allows electric current from the battery 172 to flow into the high voltage, alternating current power supply 168. Preferably, the ionization system 108 is a corona discharge ionization system.

The position of the emitter pin 142 downstream of the air induction device 104 places the pin in the forward segment 152 of the barrel 102 within the compressed gas-ambient air airstream M. The emitter pin 142, when supplied with operating voltage from the power supply, ionizes the combined airstream M. Since the current is alternating, the emitter pin 142 produces both positive and negative ions in the combined airstream M.

The ionization system 108 may also include a pin holder 140 that receives one end of the emitter pin 142 to hold the emitter pin within the barrel 102 and to connect the emitter pin to the high voltage, alternating current power supply 168. The pin holder 140 includes a means for retaining the emitter pin 142 therein that also allows the emitter pin to be removable. The means for retaining the emitter pin may include a threaded bore, a snap-fit, a press-fit, a spring-loaded catch, or other connection known to one of skill in the art. In one embodiment, the pin holder 140 is a socket, preferably a spring-loaded socket.

The emitter pin 142 being in the combined airstream M is subject to exposure to dust, dirt, or other contaminants that may collect thereon. The contaminants may degrade the efficiency of the ionizing blow-off gun 100, thus the emitter pin either needs to be cleaned or replaced after a period of use. Additionally, emitter pins erode over time simply due to use. In the past, ionizer guns were discarded when the emitter pin eroded or was contaminated. In the disclosed ionizing blow-off gun 100, the emitter pin 142 is removable from the pin holder 140 so that the emitter pin may be cleaned and returned or replaced with a new emitter pin. This is advantageous because the replaceable emitter pin extends the life of the ionizing blow-off gun.

The high voltage, alternating current power supply 168 includes an on-board DC to AC converter and a high voltage step-up transformer as seen in FIG. 6. Referring to FIG. 6, a basic block diagram of the self-contained ionization system 108 is shown, which comprises a switch 202, a battery 204, a DC to AC converter 208, a high voltage step-up transformer 212, and one or more corona discharge points 214, 216. The emitter pin 142 is represented by the corona discharge points 214, 216. Even though only two corona discharge points are shown, the ionization system is not limited thereto, i.e., a plurality of emitter pins are possible. The ionization system includes switch 202 connected to the battery 204 by connection 206 with both the switch 202 and the battery 204 connected to a DC to AC converter 208 by connections 210, 210′. The DC to AC converter 208 is connected to a high voltage step-up transformer 212 by connection 213, and the high voltage step-up transformer 212 is connected to the corona discharge emitter(s) 214, 216.

Referring to FIG. 2, the switch 176 is positioned proximal to the trigger 114 so that activation of the trigger 114 closes the switch 176. The switch may be a magnetic reed switch, or other switches known to one of skill in the art. When the switch is a magnetic reed switch, the trigger 114 includes a magnet 178. Preferably, the magnet 178 is mounted such that when the trigger 114 is moved the magnet moves with the trigger toward the switch 176 and the magnetic field around the magnet closes the magnetic reed switch.

The trigger 114 is also mounted to a valve stem 181 of a valve 184 within the compressed gas pathway 106. When the trigger is activated, the valve stem 181 is depressed and opens valve 184. The open valve 184 allows the compressed gas C to flow from the bore 113 through the valve 184 into the connection bore 186 and into the air induction device 104. Preferably, the trigger 114, when in an activated position, simultaneously opens the compressed air pathway 106 and closes switch 176. The trigger 114 also includes a spring 180 to return the trigger to an un-activated position and a trigger stop 182 to stop the trigger in the activated position. Like the trigger of a gun, trigger 114 is activateable by at least one finger of the user.

In another embodiment, the ionization system 108 further includes an indicator 130. The indicator 130 lets the user of the ionizing blow-off gun know that battery voltage is being supplied to the high voltage, alternating current power supply 168. The indicator is preferably a light, for example an LED. Alternately, the indicator may be a sound or a vibration.

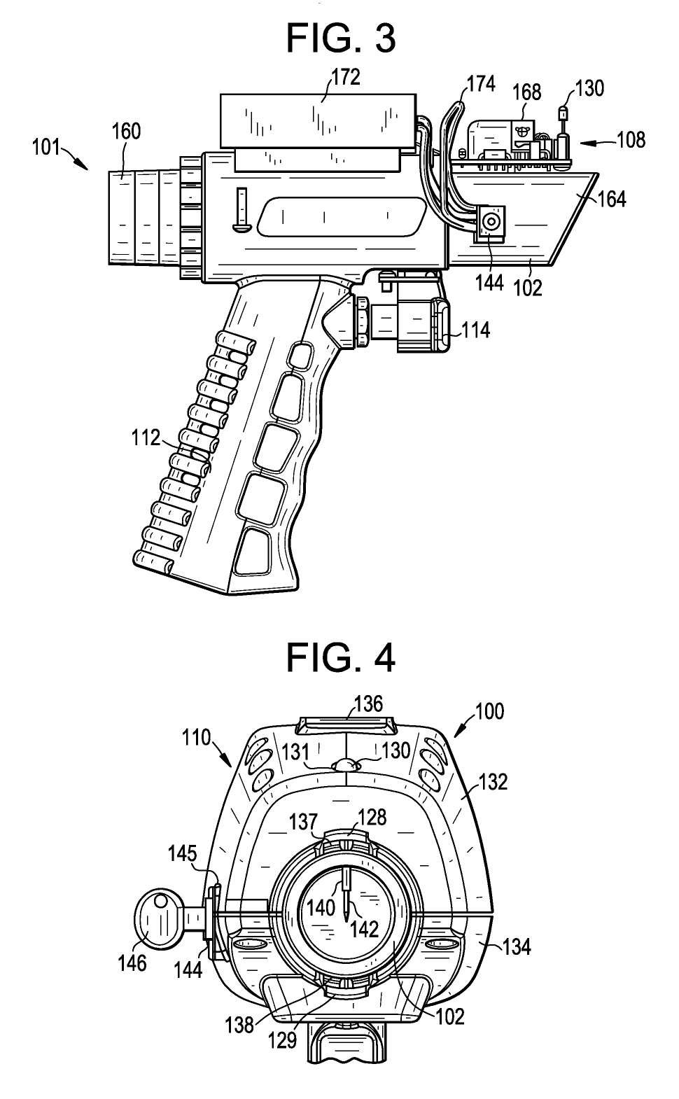

Referring now to FIG. 3, the ionizing blow-off gun without its outer housing, generally designated 101, includes the barrel 102 having a rearward end 160 and a forward end 164, the ionization system 108, the handle 112, the trigger 114, and battery 172. From this view, the ionization system 108 can be seen to include the high voltage, alternating current power supply 168 coupled to the battery by wires 174 and the battery connected to a jack 144. In this embodiment, the battery 172 is a rechargeable battery that may be recharged by plugging an adapter into the jack 144. The self-contained battery is advantageous because the ionizing blow-off gun no longer requires a cumbersome power cord to connect the gun to a high voltage power source. Furthermore, having a rechargeable battery eliminates the need to remove the outer housing which protects the internal components of the ionizing blow-off gun from risk of damage that could occur while replacing the battery. One of skill in the art will appreciate that, while one battery is referred to herein, the ionizing blow-off gun may include a plurality of batteries.

Now referring to FIG. 4, the ionizing blow-off gun 100 may include a key 146 inserted into the jack 144. In this embodiment, the jack 144 is a lock that when locked stops the electric current from flowing from the battery 172 to the high voltage, alternating current power supply 168. The key 146 is used to protect the user from risk of shock, especially when the emitter pin 142 is being removed. In another embodiment, the jack 144 is both a lock and a recharging port for a rechargeable battery.

The outer housing 110 of the ionizing blow-off gun 100 encloses the air induction device 104, the forward segment 152 of the barrel, the ionization system 108, and at least part of the rearward segment 154 of the barrel. The outer housing 110 may include a plurality of members that are assembled together to enclose the components of the ionizing blow-off gun 100. In one embodiment, the outer housing 110 includes a top member 132 and a bottom member 134. In another embodiment, the outer housing 110 may be formed of a left member and a right member. One of skill in the art will appreciate that the members may be assembled together using known techniques, for example, screws, bolts, adhesive, fusing, welding, latches, rivets, or the like.

The outer housing 110 may include an indicator opening 131 for the indicator 130, a jack opening 145 for the jack 144, and an elongate flat surface 136, preferably on the top surface, for placement of a label. In one embodiment, as seen in FIGS. 1-2 and 4, the outer housing 110 includes a first nozzle guide-arm 137 and a second nozzle guide-arm 138 each extending beyond the open forward end 164 of the barrel 102 and each terminating in a tab 128, 129, respectively, that is connectable to a nozzle 116. In the embodiment where the outer housing 110 comprises a top member 132 and a bottom member 134, the top member 132 includes the first nozzle guide-arm 137 and the bottom member 134 incudes the second nozzle guide-arm 138.

As seen in FIGS. 1-2, a nozzle 116 fits over the nozzle guide-arms 137, 138. The tabs 128, 129 at the end of the nozzle guide-arms 137, 138 hold the nozzle in place. The tabs 128, 129 may have a snap fit connection to the nozzle 116. As such, the nozzle 116 is removable by pinching the tabs 128, 129 inward toward the center of the nozzle and then sliding the nozzle off. When the nozzle 116 is removed, the emitter pin 142 is accessible for removal through the open forward end 164 of the barrel 102. Alternately, the tabs 128, 129 may have a press-fit, or other connection to the nozzle known to one of skill in the art. While the nozzle shown in FIGS. 1-2 fits over guide arms, the removable and replaceable nozzle is not limited thereto. In an alternate embodiment, the nozzle may screw onto the blow-off gun, have a snap-fit thereto, or other connection.

The nozzle 116 may include a guard 126 within the nozzle opening 117. The guard 126 may be a plurality of ribs directed across the nozzle opening to protect the user from risk of shock, in particular, from touching the emitter pin 142. The ribs may run across the nozzle opening in one direction or in a plurality of directions. The ribs, preferably, are oriented to direct the ionized airstream I toward a target surface while also protecting the user from touching the emitter pin 142.

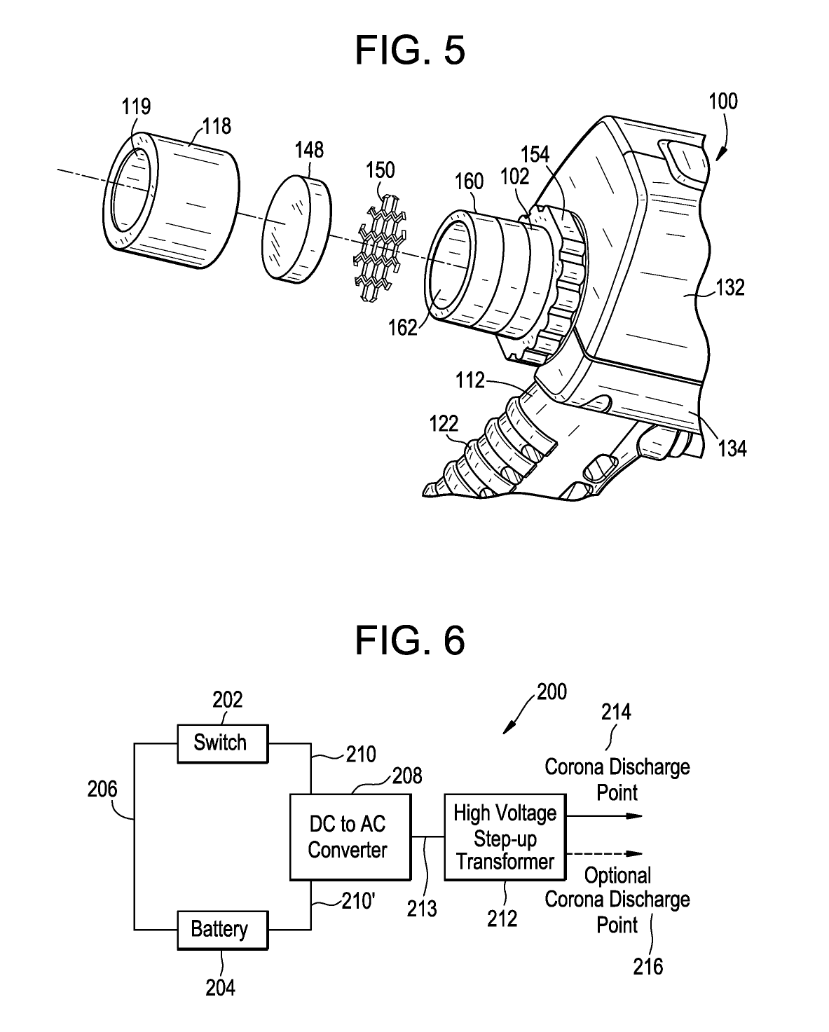

Now referring to FIG. 5, in one embodiment, the ionizing blow-off gun 100 may include a filter 148 at the rearward end 160 of the barrel 102. The filter 148 reduces the dust, dirt and other contaminants that may enter the barrel 102 with the ambient air drawn in through opening 162. The filter 148 may be held onto the barrel 102 by a cap 118 that fits onto the rearward end 160. In one embodiment, the cap 118 sandwiches the filter against a screen 150 that is adjacent to the opening 162 of the rearward end 160. The cap 118 includes a cap opening 119 that aligns with the opening 162 of the barrel 102. The cap 118 may include threading, a press-fit, a snap-fit, a latch, or other connector known to one of skill in the art to removably connect the cap to the rearward end 160. A removable cap is advantageous because it enables the filter to be removed and cleaned or replaced, which will extend the life of the ionizing blow-off gun by reducing the contaminants that can collect on the emitter pin 142.

The ionizing blow-off gun disclosed herein is designed to simultaneously neutralize static charge and dislodge particulate matter, such as dust, dirt, and other contaminants, from a surface to be cleaned. Because the ionizing blow-off gun has a self-contained, battery powered, high voltage power supply the gun does not require a separate, external, high voltage power supply and its cumbersome cabling needed to connect it to the gun. The ionizing blow-off gun also incorporates an air induction device, which reduces the consumption of compressed gas while producing significantly higher air flow rates and velocities than other battery powered ionizers. This makes the ionizing blow-off gun useful in applications involving large surfaces at reduced cost due to the use of ambient air. The ionizing blow-off gun also includes a replaceable/removable emitter pin and replaceable/removable ambient air filter, both of which extend the life of the gun and make the gun reusable and less expensive over time than typical ionizer guns. The ionizing blow-off gun further provides the advantage of being lightweight, compact, and mostly self-contained.

Since the emitter pin 142 is removable for cleaning or replacement, the ionizing blow-off gun 100 has a method of removing the emitter pin. The method includes the steps of locking the ionization system 108, removing the nozzle 116 from the forward end 164 of the barrel 102, and extracting the emitter pin 142 from the pin holder 140 through the forward end 164. Thereafter, the method may include replacing the emitter pin 142 by placing the emitter pin 142 or a new emitter pin into the pin holder 140, replacing the nozzle 116 on the forward end 164, and unlocking the ionization system 108.

Since the filter 148 is replaceable, the ionizing blow-off gun 100 also has a method of replacing the filter. The method includes the steps of removing the cap 118, removing the filter 148, replacing the filter with a cleaned or new filter, and placing the cap 118 back on the rearward end 160 of the barrel 102. The step of replacing the filter 148 may include placing the filter 148 in the cap before placing the cap 118 back on the rearward end 160. The method may also include the step of removing the screen 150 and replacing the screen. The step of removing the screen may include taking the screen 150 out of the cap 118, and the step of replacing the screen may include placing the screen 150 in the cap after the step of placing the filter 148 in the cap.

### EXAMPLE

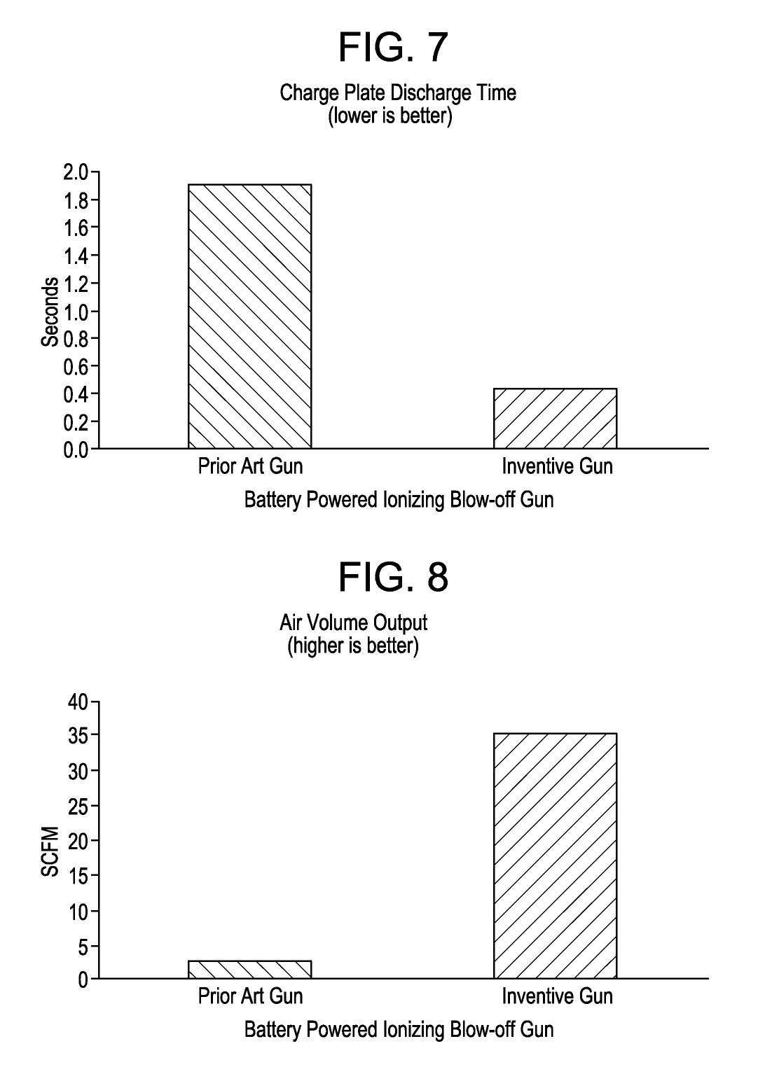

FIGS. 7 and 8 are graphical representations of comparative data for the inventive battery powered ionizing blow-off gun compared to a commercially available battery powered ionizer gun (a prior art gun) that does not have an air induction device. The prior art battery powered ionizer gun is a SEMTRONICS model 62418 IONIZING AIR GUN available from ESD Systems, at www.ESDSystems.com.

We tested the guns using a commercially available Charge Plate Analyzer and the testing protocol defined by “ESD association standard test method for Protection of Electrostatic Discharge Susceptible Items-Ionization ESD STM 3.1-2000.” The protocol specifies that the measurements be performed with the ionizer outlet at a distance of six inches from the charge plate. However, because the inventive battery powered ionizing blow-off gun delivers a significantly higher volume of moving air due to the presence of the air induction device compared to the comparative gun, it necessitated adjusting the measurement distance to thirteen inches to increase the reliability of the data.

The battery powered ionizing blow-off gun discharged the charge plate in 0.4 second, approximately one-quarter of the time required for the prior art ionizing gun to discharge the same plate (1.9 seconds) under the same environmental conditions. Each ionizer was supplied with clean dry compressed air at a pressure of 30 Pounds per Square Inch Gauge, (PSIG). During the 1.9 seconds, the prior art gun consumed and discharged approximately one Standard Cubic Foot per Minute (SCFM) of air; whereas, in 0.4 seconds the ionizing blow-off gun consumed approximately nine SCFM and discharged approximately thirty-five SCFM. The higher volume of air discharged and decreased time required are advantageous when a large target area is being cleaned off, especially when the higher volume of air is largely ambient air.

An important distinction between the battery powered ionizing blow-off gun and the prior art ionizing gun is the enhanced ability of the disclosed gun to remove particulate contaminants from an electrostatically neutralized surface. This ability can be attributed to the significantly higher volume of moving air delivered to the surface being cleaned. Although, neutralizing the electrostatic charge on a surface to be cleaned is important, it is just as important to supply enough moving air to dislodge and carry away any undesirable particulate present on that surface.

The presence of the air induction device in the ionizing blow-off gun produces relatively high airflow (high volume, high velocity) at low pressure from a relatively low flow of compressed gas, approximately nine SCFM. The relatively low pressure, in the combined airstream M, allows the ions introduced into the airstream to have a relatively long lifetime before recombining, and allows more ions to be delivered to the surface for a given energy output from the ionizing device and for a given flow of compressed gas. By contrast, a device containing a corona-discharge point or array and using a compressed gas source only to produce the same volume of gas flow will produce a lower flow of ions to the surface to be neutralized because of the greater propensity of ions to recombine in the higher-pressure airflow, hence taking longer to discharge the surface of static as seen in FIG. 7 for the prior art gun.

Having described the invention in detail and with reference to specific advantages thereof it will be apparent that numerous modifications are possible without departing from the spirit and scope of the following claims.

What is claimed is:

1. An ionizing blow-off gun comprising:
a barrel including an open rearward end for drawing in ambient air and an open forward end for discharging an ionized airstream;
an air induction device within the barrel downstream from the open rearward end;
a compressed gas pathway connected to the air induction device to direct a compressed gas into the air induction device to form a high volume, high velocity airstream of ambient and compressed air directed toward the forward end;
a self-contained ionization system comprising:
an emitter pin within the barrel downstream from the air induction device, the emitter pin being removable from the barrel;
a high voltage, alternating current power supply coupled to the emitter pin to provide the operating voltage for the emitter pin;
a battery connected to the power supply; and
a switch that allows electric current from the battery to flow into the high voltage, alternating current power supply; and
a lock coupled to the battery, wherein in the locked position the battery is disconnected from the power supply so the emitter pin can be removed without electric current flowing to the high voltage, alternating current power supply.

2. The ionizing blow-off gun of claim 1 wherein the lock is lockable by a key.

3. The ionizing blow-off gun of claim 1 wherein the lock is a recharging jack that is lockable by a key.

4. The ionizing blow-off gun of claim 1 further comprising a key for the lock.

5. The ionizing blow-off gun of claim 3 wherein the battery is a rechargeable battery.

6. The ionizing blow-off gun of claim 1 wherein the self-contained ionization system further comprises a pin holder that receives the emitter pin.

7. The ionizing blow-off gun of claim 1 wherein the ionization system is a corona discharge ionization system.

8. The ionizing blow-off gun of claim 1 wherein the emitter pin is replaceable.

9. The ionizing blow-off gun of claim 1 further comprising a nozzle aligned with the open forward end of the barrel.

10. The ionizing blow-off gun of claim 9 wherein the nozzle includes a guard within the nozzle.

11. The ionizing blow-off gun of claim 9 further comprising an outer housing enclosing the barrel.

12. The ionizing blow-off gun of claim 11 wherein the outer housing includes a first nozzle guide-arm and a second nozzle guide-arm each extending beyond the open forward end of the barrel and each terminating in a tab connectable to the nozzle.

13. The ionizing blow-off gun of claim 12 wherein the outer housing comprises a top member and a bottom member that fit together, wherein the top member includes the first nozzle guide-arm and the bottom member includes the second nozzle guide-arm.

14. The ionizing blow-off gun of claim 12 wherein the nozzle is connected to the first and second nozzle guide arms.

15. The ionizing blow-off gun of claim 1 wherein the open rearward end of the barrel includes a filter.

16. The ionizing blow-off gun of claim 15 wherein the filter is removable.

17. The ionizing blow-off gun of claim 15 further comprising a rear cap that fits onto the open rearward end of the barrel, wherein the rear cap holds the filter in place.

18. An ionizing blow-off gun comprising:
a barrel including an open rearward end for drawing ambient air into the barrel and an open forward end for discharging an ionized airstream;
an air induction device within the barrel downstream from the open rearward end;
a compressed gas pathway connected to the air induction device to direct a compressed gas into the air induction device to form a high volume, high velocity airstream of ambient and compressed air directed toward the forward end;
a self-contained ionization system comprising:
an emitter pin within the barrel downstream from the air induction device, the emitter pin being removable;
a high voltage, alternating current power supply coupled to the emitter pin to provide the operating voltage for the emitter pin;
a battery connected to the power supply; and
a switch that allows electric current from the battery to flow into the high voltage, alternating current power supply; and
a nozzle coupled to the open forward end of the barrel, the nozzle being removable to provide access to the emitter pin.

19. The ionizing blow-off gun of claim 18 further comprising a filter at the open rearward end of the barrel, wherein the filter is removable.

20. The ionizing blow-off gun of claim 19 further comprising a rear cap that fits onto the open rearward end of the barrel, wherein the rear cap holds the filter in place.

21. The ionizing blow-off gun of claim 18 further comprising a guard within the nozzle.

22. An ionizing blow-off gun comprising:
a barrel including an open rearward end for drawing ambient air into the barrel and an open forward end for discharging an ionized airstream;
an air induction device within the barrel downstream from the open rearward end;
a compressed gas pathway connected to the air induction device to direct a compressed gas into the air induction device to form a high volume, high velocity airstream of ambient and compressed air directed toward the forward end;
a self-contained ionization system comprising:
an emitter pin within the barrel downstream from the air induction device;
a high voltage, alternating current power supply coupled to the emitter pin to provide the operating voltage for the emitter pin;
a battery connected to the power supply; and
a switch that allows electric current from the battery to flow into the high voltage, alternating current power supply;
and a trigger that upon activation opens the compressed air pathway and closes the switch.

23. The ionizing blow-off gun of claim 22 wherein the switch is a magnetic reed switch and the trigger includes a magnet.

24. The ionizing blow-off gun of claim 22 wherein the trigger is depressible by at least one finger.
